(19) United States
(12) Patent Application Publication
(10) Pub. No.: US 2007/0069961 A1
(43) Pub. Date: Mar. 29, 2007

(54) Magnetic core member for antenna module, antenna module and portable information terminal equipped with antenna module

(75) Inventors: Hiraku Akiho, Miyagi (JP); Hiroyuki Ryoson, Kanagawa (JP); Kazuo Goto, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 10/595,279

(22) PCT Filed: Jul. 19, 2005
(86) PCT No.: PCT/JP05/13231

§ 371 Date: Apr. 4, 2006

(30) Foreign Application Priority Data
Aug. 4, 2004 (JP) 2004-228559

(51) Int. Cl. H01Q 1/24

(52) U.S. Cl. 343/702

(57) ABSTRACT

There are provided a magnetic core member for an antenna module capable of improving a communication distance without thickening the module, an antenna module, and a portable information terminal equipped with the antenna module. A magnetic core member 18 for an antenna module 10 of the present invention has a ring groove 18c as a recess portion formed on the surface on the side stacking an antenna coil 15 in an area facing a loop portion of the antenna coil 15. An eddy current generated in the magnetic core member 18 in a high frequency magnetic field is concentrated on the surface of the magnetic core member 18 on the side stacking the antenna coil 15 in the area facing the loop portion of the antenna coil 15. According to the present invention, a ring groove 18c is provided in the area to reduce an amount of eddy currents to be generated and improve the communication distance characteristics of the antenna module.

### TECHNICAL FIELD

The present invention relates to a magnetic core member for an antenna module suitable for use with a non-contact IC tag utilizing radio frequency identification (RFID) techniques, an antenna module and a portable information terminal equipped with the antenna module.

### BACKGROUND ART

Conventionally, a device having an IC chip with recorded information and a resonance capacitor electrically connected to an antenna coil is known as a non-contact IC card and an identification tag utilizing RFID techniques (hereinafter, these are collectively called a “non-contact IC tag”).

A non-contact IC tag is activated upon transmission of radio waves having a predetermined frequency (e.g., 13.56 MHz) from a transmission/reception antenna of a reader/writer, with an antenna coil of the non-contact IC tag. And, individual identification or authentication management becomes possible upon reading information recorded in an IC chip in response to a read command through data communications via radio waves, or upon resonance to radio waves of the specific frequency. In addition to this, most of non-contact IC tags are structured so that read information can be renewed or history information and the like can be written.

A main conventional antenna module used for a non-contact IC tag has the structure that a magnetic core member is inserted into an antenna coil wound in a spiral shape along a flat plane, generally in parallel to the flat plane of the antenna coil (refer to Japanese Patent Application Publication No. 2000-48152). The magnetic core member of the antenna module is made of a high permeability material such as an amorphous sheet and an electromagnetic steel plate and the magnetic core member is inserted generally in parallel to the flat plane of the antennal coil to increase an inductance of the antenna coil and improve a communication distance.

Japanese Patent Application Publication No. 2000-113142 discloses an antenna module having a structure that planar magnetic core members are stacked in parallel to a flat plane of an antenna coil wound in a spiral shape along the flat plane.

Portable information terminals widely prevailed recently such as personal digital assistants (PDA) and portable phones are carried about during an outing or the like and always held by users. Therefore, if a portable information terminal is provided with the functions of a non-contact IC tag, it is not necessary for a user to have, for example, a non-contact IC card in addition to the portable information terminal always held by the user, and it becomes very convenient for the user. Techniques of building the functions of a non-contact IC tag into a portable information terminal in this manner are disclosed in, for example, Japanese Patent Application Publication No. 2003-37861 and have already proposed by the present applicant (Japanese Patent Application Serial Number 2004-042149).

A portable information terminal is compact on one hand and is an apparatus having multi-functions on the other hand, so that metal components are mounted in a compact housing at a high density. For example, some printed wiring boards now in use have a multi-layer conductive layer, and electronic components are mounted on a multi-layer printed wiring board at a high density. A battery pack as a power source is accommodated in a portable information terminal, and metal components are used for a package and the like in this battery pack.

Therefore, an antenna module for a non-contact IC tag disposed in the housing of a portable information terminal has a degraded communication performance and, for example, a tendency that its communication distance becomes short, more than a separated antenna module before it is assembled in the housing, because of the influence of metal components mounted in the housing.

As the communication distance of an antenna module becomes short, it becomes necessary for the antenna module to be set as near the reader/write as possible in real use, possibly resulting in damaging the convenience of a non-contact IC card system capable of transferring information easily and quickly. Even if an antenna module is used by being accommodated in the housing of a portable information terminal, a communication distance of at least 100 mm is considered necessary. This conforms to the specification of a non-contact IC card system for railroad automatic ticket examination presently in use.

### DISCLOSURE OF THE INVENTION

[Problem to Be Solved By the Invention]

High permeability magnetic powders have been used conventionally as a magnetic core member in order to improve a communication distance of an antenna module. If magnetic powders are mixed with binder and shaped in a sheet member or plate member to use the member as a magnetic core member, a permeability of the whole magnetic core member can be increased by making large the particle size of magnetic powders.

However, as the particle size of magnetic powders is made large, a power loss caused by an eddy current loss of the magnetic core member becomes conspicuous, with an IC read voltage lowered and a communication distance shortened. More specifically, as a magnetic substance is magnetized in a high frequency magnetic field, a change in magnetic fluxes corresponding to the frequency occurs. According to electromagnetic induction law, an electromotive force is generated in the direction cancelling the change in magnetic fluxes. Induction current by the generated electromotive force is converted into Joule heat. This is the eddy current loss.

In order to reduce the eddy current loss while a permeability of a magnetic core member is maintained high, most of conventional approaches are to limit a large particle size of magnetic powders and reduce an absolute quantity of magnetic powders to be mixed.

However, to reduce the absolute quantity of magnetic powders results in a thick and large magnetic core member, and in a thick antenna module. For example, a sheet thickness of a conventional magnetic core member having the structure described above is at least over 1 mm in order to obtain a communication distance of 100 mm of the magnetic core itself. The module thickness increases further by laminating a board for supporting the antennal coil and a shield plate for eliminating the influence of a metal portion inside the housing.

Recently, a portable information terminal is much more reqired compact and thin, and there is no room left in the housing of the portable information terminal for accommodating an antenna module of a large or thick size. As described above, an antenna module built in a compact electronic apparatus such as a portable information terminal is required to satisfy two contradictory requests for further improving a communication distance and further thinning a module thickness.

The present invention has been made in consideration of the above-described problems and has an issue of providing a magnetic core member for an antenna module capable of improving a communication distance without thickening the module, an antenna module and a portable information terminal equipped with the antenna module.

[Means for Solving the Problem]

In order to solve the above issue, the present inventors have vigorously studied and found that an eddy current in a magnetic core member is generated on the surface facing an antenna coil stacked, and concentrated on an area facing a loop portion of the antenna coil. It has been found that by forming a recess portion in this area, a generation amount of eddy currents can be reduced.

Namely, the magnetic core member for an antenna module of the present invention is characterized in that the recess portion is formed on the surface facing the stacked antenna coil, at least in an area facing the loop portion of the antenna coil.

By forming the recess portion, a gap corresponding to a depth of the recess portion is formed between the surface of the magnetic core member and the loop portion of the antenna coil, and intervention of this gap reduces the amount of eddy currents to be generated on the surface of the magnetic core member. The deeper the recess portion is, the generation of eddy current can therefore be expected to be suppressed. However, since the magnetic core member is positioned away from the loop portion of the antenna coil, the inductance of the antenna coil reduces and the communication distance is degraded. To avoid this, according to the present invention, an area where the recess portion is formed is set to at least the area facing the loop portion of the antenna coil to balance between reduction of the amount of the eddy current generation and prevention of the inductance from being lowered.

A depth of the recess portion can be properly set in accordance with the magnetic characteristics of the magnetic core member. Namely, since an eddy current is generated more as the magnetic core member has a higher conductivity, a depth of the recess portion may be shallow if the magnetic core member having a low conductivity is used. For example, if a communication frequency of the antenna coil is 13.56 MHz and the magnetic core member (0.58 mm thick) is formed by mixing Fe—Si—Cr system magnetic powders in binder, then a depth of the recess portion is set to 0.1 mm or shallower in order to acquire a communication distance of 100 mm or longer in the state that the antenna coil is accommodated in the housing of a portable information terminal.

The shape of the recess portion is not limited specifically, but the recess portion may be a ring groove formed in correspondence with the loop portion of the antenna coil or dimples formed on the surface of the magnetic core member at a plurality of positions.

### BRIEF DESCRIPTION OF THE DRAWINGS

FIG. 1 is a broken perspective view of an antenna module 10 according to an embodiment of the present invention.

FIG. 2 is a cross sectional side view showing a main part of the antenna module 10.

FIG. 3 is a schematic diagram showing an inner structure of a portable information terminal 1 with the built-in antenna module 10, as viewed sideways.

FIG. 4 is a partially broken back view of the portable information terminal 1.

FIG. 5 is a diagram showing an example of a relation between a real part μ′ and an imaginary part μ″ of a permeability of a magnetic core material 18.

FIG. 6 is a plan view of the magnetic core member 18.

FIG. 7 is a plan view showing another example of the structure of a magnetic core member 18′.

FIGS. 8A and 8B are distribution diagrams of eddy currents generated on the surface of a magnetic core member. FIG. 8A shows a magnetic core member 18 having a ring groove 18c formed on the surface thereof, and FIG. 8B shows a magnetic core member 18″ whose surface is not worked.

FIG. 9 is a diagram illustrating a relation between a depth of the ring groove 18c and an inductance L, a resistance R and a Q value respectively of the antenna coil.

FIG. 10 is a diagram comparing L, R and Q of an antenna coil using a magnetic core member with a recess portion (ring groove 18c, dimples 18d) with L, R and Q of an antenna coil using a magnetic core member having a conventional shape whose surface is not worked.

FIG. 11 is a diagram comparing a communication distance of the antenna coil using the magnetic core member with the recess portion (ring groove 18c, dimples 18d) with a communication distance of an antenna coil using the magnetic core member having the conventional shape whose surface is not worked.

### BEST MODE FOR CARRYING OUT THE INVENTION

An embodiment of the present invention will be described in the following by referring to the drawings.

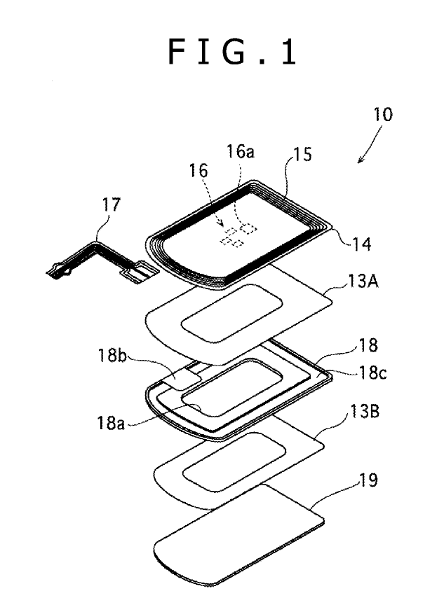

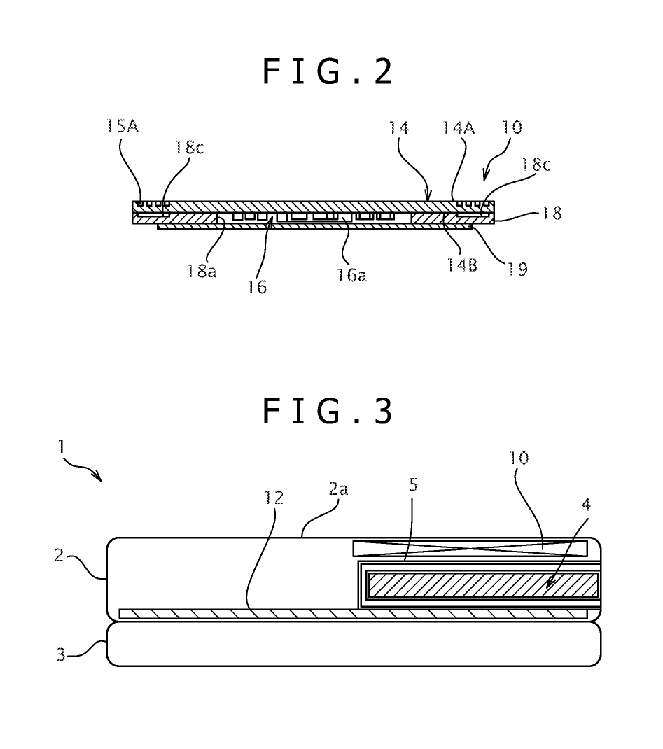

FIG. 1 and FIG. 2 are a broken perspective view and a cross sectional side view showing the structure of an antenna module 10 for non-contact data communications according to an embodiment of the present invention.

The antenna module 10 has a lamination structure of a baseboard 14 as a support body, a magnetic core member 18 and a metal shield plate 19. The baseboard 14 and magnetic core member 18 are stacked via an adhesive double coated sheet 13A, and the magnetic core member 18 and metal shield plate 19 are stacked via an adhesive double coated sheet 13B. In FIG. 2, the double-sided adhesive sheets 13A and 13B are not shown in the drawing.

Although the baseboard 14 is configured as an insulating flexible board made of a plastic film such as polyimide, polyethylene terephthalate (PET) and polyethylene naphthalate (PEN), it may be structured as a rigid board such as glass epoxy resin.

An antenna coil 15 wound in a loop shape in a flat plane is mounted on the baseboard 14. The antenna coil 15 is used for a non-contact IC tag function and makes communications through inductive coupling with an antenna portion of an external reader/writer (not shown in the drawing). The antenna coil 15 is made of a metal of copper, aluminum or the like patterned on the baseboard 14.

In this embodiment, the antenna coil 15 is composed of a loop part wound in the flat plane and a wiring part for electric connection to a signal processing circuit unit 16 to be described later, only the loop part shown in the drawing.

A second antenna coil for a reader/write function may be mounted on the antenna module 10. In this case, the second antenna coil may be mounted on the baseboard 14 on an inner side of the antennal coil 15.

The signal processing circuit unit 16 is mounted on the surface of the baseboard 14 on the side of the magnetic core member 18. The signal processing circuit unit 16 is disposed on the inner side of the antenna coil 15 and electrically connected to the antenna coil 15.

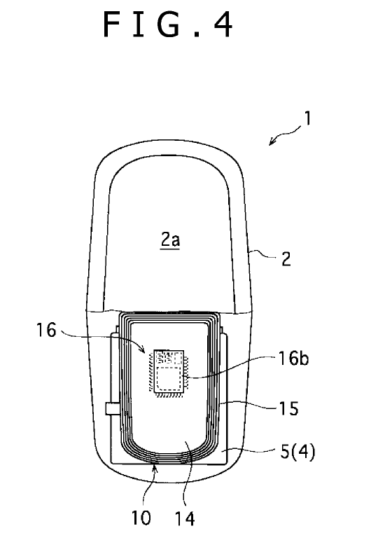

The signal processing circuit unit 16 is composed of an IC chip 16a including a signal processing circuit necessary for non-contact data communications and storing information, and electric/electronic components such as a tuning capacitor. The signal processing circuit unit 16 may be composed of a group of a plurality of components such as shown in FIG. 1 and FIG. 2, or may be composed of a single component 16b such as shown in FIG. 4. The signal processing circuit unit 16 is connected to a printed wiring board 12 (FIG. 3) of a portable information terminal 1 to be described later, via an external connection unit 17 mounted on the baseboard 14.

The magnetic core member 18 is an injection molding body formed in a sheet member or plate member, for example, by mixing or filling soft magnetic powders with or in insulating binder such as synthetic resin and rubber. As soft magnetic powders, Sendust (Fe—Al—Si system), Permalloy (Fe—Ni system), amorphous (Fe—Si—B system), ferrite (Ni—Zn ferrite, Mn—Zn ferrite, etc.), sintered ferrite and the like may be adopted, which are selectively used in accordance with a desired communication performance and usage.

The magnetic core member 18 functions as a magnetic core of the antenna coil 15, and avoids electromagnetic interference between the antenna coil 15 and the metal shield plate 19. An opening 18a is formed through a center region of the magnetic core member 18 in order to accommodate the signal processing circuit unit 16 mounted on the baseboard 14. A recess 18b is provided at one side of the magnetic core member 18, the recess being used for the external connection unit 17 during stacking on the baseboard 14.

The details of the magnetic core member 18 will be later described.

The metal shield plate 19 is made of a stainless plate, a copper plate, an aluminum plate or the like. As will be later described, the antenna module 10 of this embodiment is accommodated at a predetermined inner position of a terminal main body 2 of the portable information terminal 1. Therefore, the metal shield plate 19 is provided to protect the antenna coil 15 from electromagnetic interference with a metal portion (components, wirings) on a printed wiring plate 12 in the terminal main body 2.

The metal shield plate 19 is used for coarse adjustment of a resonance frequency (in this example, 13.56 MHz) of the antenna module 10, and is used for suppression of large variations in resonance frequency of the antenna module 10 between the states where the antenna module 10 resides alone, and the antenna module is assembled in the terminal main body 2.

FIG. 3 and FIG. 4 are schematic diagrams showing a state that the antenna module 10 having the above-described structure is assembled in the portable information terminal 1. FIG. 3 is a schematic diagram showing the inside of the terminal main body 2 as viewed sideways, and FIG. 4 is a partially broken diagram showing the inside of the terminal main body 2 as viewed from a back side.

The portable information terminal 1 shown in the drawings is structured as a portable phone having the terminal main body 1 and a panel unit 3 rotatably mounted on the terminal main body 1. In FIG. 3, the terminal main body 2 constitutes a housing made of synthetic resin, and on the surface of the panel unit 3 provided is an operation panel disposed with ten-key input buttons and the like although not shown.

The terminal main body 2 has therein a battery pack 4 for supplying power, and the printed wiring plate 12 as a control panel for controlling the functions or operations of the portable information terminal 1. The battery pack 4 is, for example, a lithium ion battery. Its overall shape is a rectangular solid, and its outer housing is made of metal material such as aluminum. The battery pack 4 is disposed inside a partition member 5 made of plastic disposed in the terminal main body 2.

The antenna module 10 is accommodated in the terminal main body 2. In this embodiment in particular, the antenna module 10 is accommodated just above the partition member 5 for housing the battery pack 4, facing a back surface 2a of the terminal main body 2. The accommodation position of the antenna module 10 is not limited to the position described above.

Therefore, for data communications with an external reader/writer (not shown in the drawing) by using the antenna module 10, the back surface 2a of the terminal main body 2 of the portable information terminal 1 is moved near to the antenna portion of the reader/writer. As an electromagnetic wave or a high frequency magnetic field irradiated from the antenna portion of the reader/writer passes through the antenna coil 15 of the antenna module 10, induction current flows through the antenna coil 15 corresponding in amount to the intensity of the electromagnetic wave or high frequency magnetic field. This induction current is rectified by the signal processing circuit unit 16 and converted into a read voltage for reading information recorded in the IC chip 16a. The read information is modulated by the signal processing circuit unit 16 and transmitted to the antenna portion of the reader/writer via the antenna coil 15.

Generally, when a soft magnetic substance (hereinafter simply called a magnetic substance) which has a high permeability, is applied with a high frequency magnetic filed, the magnetic substance is magnetized by a magnetization mechanism such as magnetic domain wall displacement and rotation magnetization. A permeability indicating a degree of magnetization feasibility is represented by a complex permeability and expressed by the following equation (1):
μ=μ′−i·μ″ (1)

where μ′ is a real part of a permeability representing the components capable of following an external magnetic field, whereas μ″ represents an imaginary part of the permeability representing the components unable to follow an external magnetic field and the components whose phase is delayed by 90°, which is called a loss term of the permeability. i represents an imaginary unit.

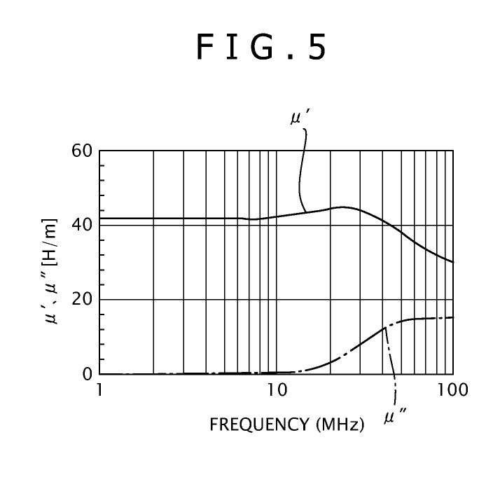

There is a close relation between the real part and imaginary part of a permeability, and the material having a larger real part of a permeability has a larger imaginary part. It is known that the permeability becomes lower as the frequency of an applied magnetic field becomes higher when a magnetic substance is magnetized by applying a high frequency magnetic field. FIG. 5 shows an example of the magnetic characteristics of a magnetic core member using Fe—Si—Cr system as magnetic powders. It is understood that as the frequency becomes higher, μ′ becomes lower and μ″ becomes higher. A loss coefficient of a magnetic substance at an applied frequency is expressed by the following equation (2) by using the real part μ′ and imaginary part μ″ of a complex permeability μ expressed by the equation (1):
tan δ=μ″/μ′ (2)

A high frequency loss by dynamic magnetization of a magnetic substance is equivalent to the loss coefficient, and can be expressed as a sum of three types of energy losses as shown in the following equation (3):
tan δ=tan δh+tan δe+tan δr (3)

where tan δh is a hysteresis loss and a work volume of a magnetization change indicated by a hysteresis curve, which increases in proportion to a frequency. tan δe is an eddy current loss which is an energy loss consumed as Joule heat converted from an eddy current induced in a conductive magnetic substance and corresponding in amount to a change in magnetic fluxes when an a.c. magnetic field is applied to the magnetic substance. tan δr is a residual loss which is a remaining loss other than the above-described losses.

An eddy current loss (tan δe) in a high frequency magnetic field at 13.56 MHz is influenced by conductivity and becomes large in proportion to the frequency used as shown in the following equation (4):
tan δe=e2·μ·f·σ (4)
where e2 is a coefficient, μ is a permeability, f is a frequency, and σ is a conductivity.

As described above, the magnetic core member 18 constituting the antenna module 10 has an increased eddy current loss at a higher conductivity. An eddy current generated in the magnetic core member 18 acts in a direction of cancelling an external magnetic field so that an induction current flowing through the antenna coil 15 is reduced. Namely, the eddy current generated in the magnetic core member 18 becomes resistance components relative to the current flowing through the antenna coil 15. The resistance components cause adverse effects such as lowering an IC read voltage and shortening a communication distance of radio waves transmitted from the antenna coil 15. It is therefore necessary to suppress the eddy current generated in the magnetic core member 18 as much as possible.

An eddy current generated in the magnetic core member 18 appears conspicuously on the surface facing the antenna coil 15. It is determined that an eddy current is generated and concentrated particularly in the region of the surface facing a loop portion of the antenna coil 15. In this embodiment, a recess portion 18c is formed on the surface of the magnetic core member 18 in an area facing a loop portion of the antenna coil 15, covering the whole circumference of the loop portion to thereby reduce a generation quantity of an eddy current.

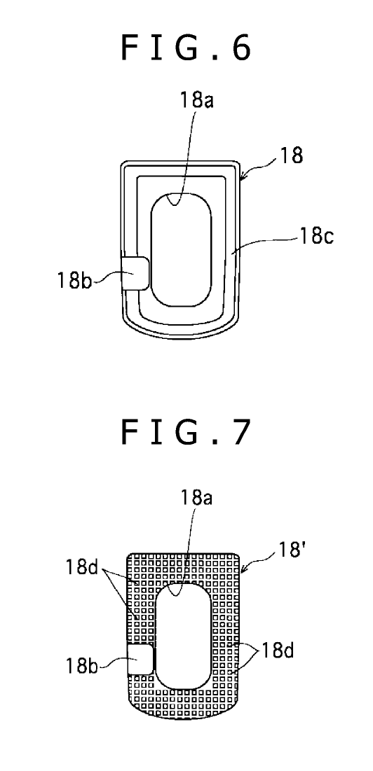

As shown in FIG. 1 and FIG. 6, the magnetic core member 18 of this embodiment is provided with a ring groove 18c as the recess portion in the region facing the loop portion of the antenna coil 15. A width of the ring groove 18c is wider than the whole width of the loop portion of the antenna coil 15.

Instead of the ring groove 18c, a plurality of dimples 18d may be provided as the recess portion on the stacked surface of the antenna coil 15, like a magnetic core member 18′ shown in FIG. 7. In the example shown in the drawing, although the dimples 18d are provided over the whole surface of the magnetic core member 18′, it is sufficient if the dimples are formed at least in the region facing the loop portion of the antenna coil.

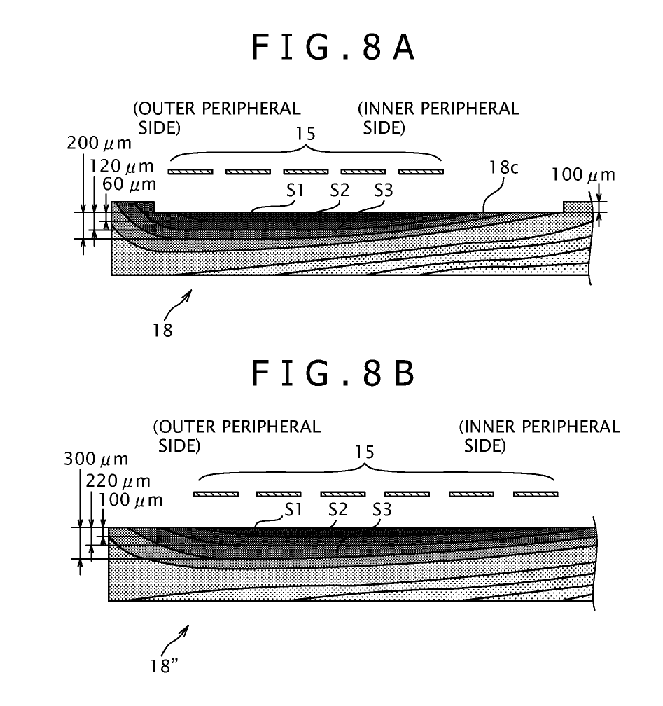

FIGS. 8A and 8B are diagrams showing the distributions of eddy currents generated in the region facing the loop portion of the antenna coil 15 along a depth direction from the surface of the magnetic core member. FIG. 8A shows the magnetic core member 18 formed with the ring groove 18c, and FIG. 8B shows a magnetic core member 18″ having a conventional configuration not worked with the ring groove 18c (dimples 18d). The distribution on gray scale gradation in the drawing is indicated by borderlines indicating the distribution of eddy currents generation in the thickness direction of the magnetic core member. The densest region S1 on the surface facing the antenna coil 15 has the largest amount of eddy current generation, and the amount of eddy current generation reduces from the region S2 to the region S3 in order.

In the magnetic core member 18″ shown in FIG. 8B, the depths of the regions S1 to S3 from the surface were 100 μm in the region S1, 200 μm in the region S2, and 300 μm in the region S3. In contrast, as shown in FIG. 8A, in the magnetic core member 18 formed with the ring groove (recess portion) 18c, the depths of the regions S1 to S3 from the surface (bottom of the ring groove 18c) were 60 μm in the region S1, 120 μm in the region S2, and 200 μm in the region S3. A depth of the ring groove 18c is 100 μm.

The distribution of eddy current generation is obtained by a computerized electromagnetic field simulation by a finite element method. Both the magnetic core members 18 and 18″ are made of the same composite magnetic material formed by dispersing magnetic powders of Fe—Si—Cr system in binder and shaped in the sheet member. A thickness of each of the magnetic core members is 0.58 mm and an external high frequency magnetic field has a frequency of 13.56 MHz.

As described above, the depth of each of the regions S1 to S3 of the magnetic core member 18 formed with the ring groove 18c, along the magnetic core member depth direction, is made thinner than that of the magnetic core member 18″ shown in FIG. 8B whose surface is not worked. The eddy current generation amount particularly in the region S1 on the uppermost surface side is reduced greatly. It is understood that a gap having a size corresponding to the depth of the ring groove 18c is provided between the loop portion of the antenna coil 15 and the surface of the magnetic core member 18, and intervention of this gap reduces the eddy current generation amount on the surface of the magnetic core member 18.

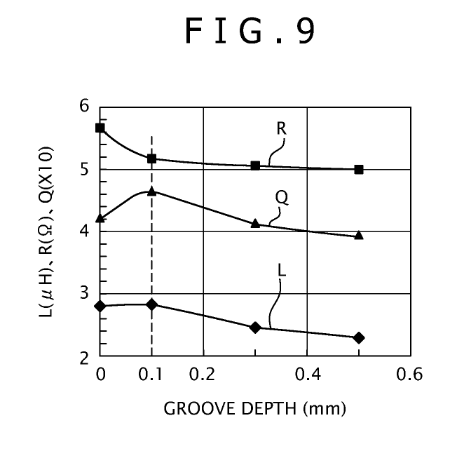

If the depth of the ring groove 18c to be formed is made deeper, the eddy current generation amount on the surface of the magnetic core member 18 can be reduced. FIG. 9 shows a relation between a depth of the ring groove 18c, an inductance L, a resistance R, and a Q value respectively of the antenna coil 15. It can be seen that as the ring groove 18c becomes deeper, the resistance R of the antenna coil lowers. This means that as the eddy current amount on the surface of the magnetic core member 18 reduces, current comes to flow easily through the antenna coil.

As seen from FIG. 9, as the ring groove 18c becomes deeper, the inductance of the antenna coil has a tendency that the inductance lowers from 0.1 mm. The reason for this is probably that as the surface of the magnetic core member 18 moves away from the surface of the loop portion of the antenna coil 15, the function of the magnetic core member 18 as a magnetic core lowers so that the inductance L of the antenna coil 15 lowers. At the same time, the Q value represented by (ωL)/R tends to lower as the depth of the ring groove 18c exceeds 0.1 mm.

Further in this embodiment, the surface area of the magnetic core member 18 on which the ring groove 18c is formed is limited only to the region facing the loop portion of the antenna coil 15. Since it is possible to dispose the other surface area of the magnetic core member 18 near at the antenna coil 15, the inductance of the antenna coil can be prevented from being lowered. The depth of the ring groove 15c is configured by considering a balance between reduction of the amount of the eddy current generation by forming the ring groove 15c, and prevention of the inductance from being lowered.

As described above, in this embodiment the highest Q value of the antenna coil 15 and the most excellent communication distance characteristics can be obtained when the depth of the ring groove 18c of the magnetic core member 18 is selected 0.1 mm (100 μm).

The depth of the ring groove 18c may be varied with magnetic powders of the magnetic core member 18 and a use frequency. Namely, since the amount of the eddy current generation reduces if a conductivity of the magnetic core member is low, the depth of the ring groove can be made shallow. This is because the eddy current loss is proportional to the loss term represented by the imaginary part (μ″) of the permeability of the magnetic core member (refer to the equations (1) to (4)). Therefore, if the μ″ components are large, the ring groove 18c is made deeper. If a used frequency is low, the eddy current generation amount reduces so that the ring groove can be made shallow.

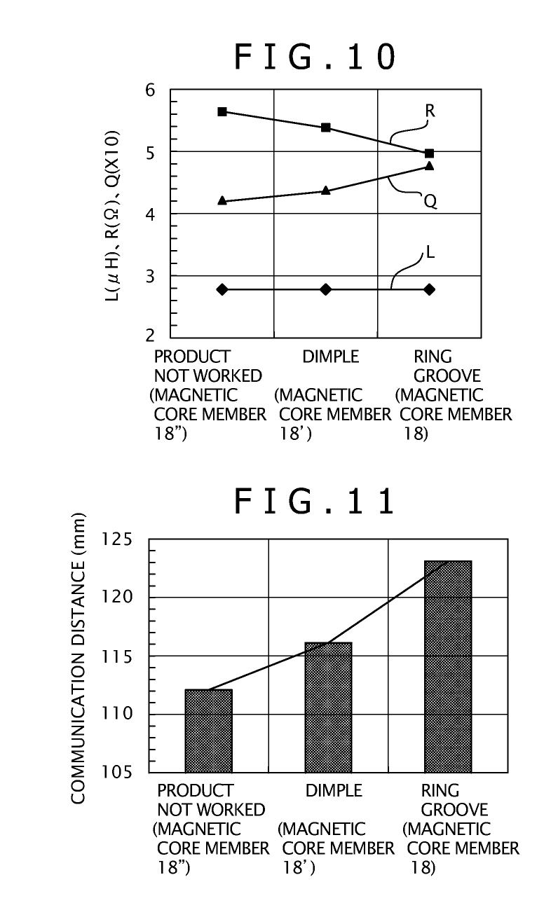

FIG. 10 shows an inductance L, a resistance R, and a Q value respectively of the antenna coil 15 measured in a high frequency magnetic field (13.56 MHz) for comparison between a magnetic core member with the ring groove 18c (magnetic core member with the ring groove 18c) 18, a magnetic core member with the dimples 18d (magnetic core member with the dimples 18d) 18′, and a magnetic core member 18″ having a conventional configuration whose surface is not worked.

The magnetic core member 18′ with the dimples 18d uses as the source material the same composite magnetic material as that of the magnetic core members 18 and 18″ and the dimples 18d are formed on the whole surface area shown in FIG. 7. A depth of each dimple 18d is 100 μm and the dimples 18d occupy 50% in area ratio.

As shown in FIG. 10, although a change in the inductance L is not observed, the resistance R of the magnetic core member 18′ with the dimples 18d and the magnetic core member 18 with the ring groove 18c is smaller than that of the magnetic core member 18″ whose surface is not worked. The resistance R of the magnetic core member 18 with the ring groove 18c is smaller than that of the magnetic core member 18′ with the dimples 18d. As a result, the Q values of the magnetic core member 18′ with the dimples 18d and the magnetic core member 18 with the ring groove 18c are higher than that of the magnetic core member 18″ whose surface is not worked, so that the communication distance can be improved.

The resistance R of the magnetic core member 18 with the ring groove 18c is smaller than that of the magnetic core member 18′ with the dimples 18d. This is because the whole surface area facing the loop portion of the antenna coil 15 faces the antenna coil (loop portion) by means of the ring groove 18c via a constant gap so that the reduction effect of the eddy current amount generated on the surface can be enhanced.

FIG. 11 is a diagram comparing communication distances (communication distances in an assembled state in the portable information terminal 1) of the magnetic core member 18 with the ring groove 18c, magnetic core member 18′ with the dimples 18d and magnetic core member 18″ whose surface is not worked. As apparent from this example, a communication distance can be improved greatly by the magnetic core member 18 with the ring groove 18c (communication distance of 116 mm) and the magnetic core member 18′ with the dimples 18d (communication distance of 123 mm), more than the magnetic core member 18 whose surface is not worked (communication distance of 112 mm).

Even the magnetic core member 18″ whose surface is not worked retains a communication distance of 100 mm or longer in the state assembled in the portable information terminal. The magnetic core member 18″ is made of novel magnetic material found during the development process of new magnetic core members by the present inventors, the details of which were proposed by the present applicant (Japanese Patent Application No. 2004-131925).

As described above, according to the embodiment, a recess portion (ring groove 18c, dimples 18d) having a predetermined depth is formed on the surface of the magnetic core member 18 (18′) facing the antenna coil 15 in the region facing the loop portion of the antenna coil 15. Accordingly, an amount of eddy currents generated on the surface of the magnetic core member 18 (18′) during non-contact data communications can be reduced so that a power loss by an external magnetic field can be reduced and the communication distance of the antenna module 10 can be improved.

Since only the recess portion (18c, 18d) is formed on the surface of the magnetic core member 18 (18′), the communication distance of the antenna module 10 can be improved without thickening the magnetic core member, and the antenna module 10 can be mounted compactly on a small electronic apparatus such as the portable information terminal 1.

The embodiment of the present invention has been described above. It is obvious that the present invention is not limited to the embodiment, but various modifications are possible in accordance with the technical idea of the present invention.

For example, in the embodiment, although the ring groove 18c or a plurality of dimples 18d are formed as the recess portion on the surface of the magnetic core member 18, the shape of the recess portion is not limited to these groove and dimples, but other shapes may be used. The magnetic core member of the present invention is intended to include the structure that a magnetic support layer for supporting the antenna board 14 is stacked on the surface of a magnetic sheet surface in an area excluding the area facing the loop portion of the antenna coil. In this case, a thickness of the magnetic support layer corresponds to a thickness of the recess portion.

Further, in the embodiment, non-conductive material such as synthetic resin may be embedded in the inside of the ring groove 18c or a plurality of dimples 18d formed on the surface of the magnetic core member 18. In this case, an eddy current is prevented from being formed on the magnetic core member surface in the area facing the loop portion of the antenna coil so that the communication distance can be improved.

Furthermore, in the embodiment, although Fe—Si—Cr system are used as soft magnetic powders constituting the magnetic core member, it is obvious that other soft magnetic powders may be used such as Sendust system, amorphous system, and ferrite system.

### INDUSTRIAL APPLICABILITY

According to the magnetic core member for an antenna module of the present invention, the recess portion is provided in the area facing the loop portion of the antenna coil. Accordingly, an eddy current generated on the surface of the magnetic core member can be reduced so that an eddy current loss of the magnetic core member can be reduced, and the communication distance of the antenna coil can be improved.

According to the antenna module of the present invention, it is possible to improve the communication distance of the antenna coil without thickening the magnetic core member, and is possible to mount the antenna module compactly without enlarging the housing size of, for example, a portable information terminal.

1. A magnetic core member for an antenna module, said member stacked for a loop-shaped antenna coil, characterized in that:
a recess is provided on a surface thereof facing said stacked antenna coil, at least in an area facing the loop portion of said antenna coil.

2. The magnetic core member for an antenna module, as described in claim 1, characterized in that:
said recess is a ring-shaped groove formed in a region corresponding to the loop portion of said antenna coil.

3. The magnetic core member for an antenna module, as described in claim 1, characterized in that:
said recess is dimples formed on the surface of said member at a plurality of positions.

4. The magnetic core member for an antenna module, as described in claim 1, characterized in that:
depth of said recess is less than 0.1 mm.

5. An antenna module having a loop-shaped antenna coil formed on a base, said base stacked by a magnetic core member, said antenna module characterized in that:
said magnetic core member is provided with a recess formed on a surface on which said base is stacked, at least in an area facing the loop portion of said antenna coil.

6. The antenna module as described in claim 5, characterized in that:
said recess is a ring-shaped groove formed in a region corresponding to the loop portion of said antenna coil.

7. The antenna module as described in claim 5, characterized in that:
said recess is dimples formed on the surface of said core member at a plurality of positions.

8. The antenna module as described in claim 5, characterized in that:
depth of said recess is less than 0.1 mm.

9. The antenna module as described in claim 5, characterized in that:
a metal shield plate is provided with said magnetic core member on a surface thereof opposite to the surface on which said base is stacked.

10. The antenna module as described in claim 5, characterized in that:
a signal processing circuit unit electrically connected to said antenna coil is mounted on said base.

11. The antenna module as described in claim 10, characterized in that:
said signal processing circuit unit is mounted on a surface of said base, facing said magnetic core member, and an opening is provided in said magnetic core member for accommodating said signal processing circuit unit.

12. The antenna module as described in claim 5, characterized in that:
said magnetic core member is formed as a sheet by dispersing magnetic powders of Fe—Si—Cr system into binder.

13. A portable information terminal having a housing wherein a base for supporting a loop-shaped antenna coil, a magnetic core member stacked on said base, and a metal shield plate stacked on said magnetic core member are mounted in the housing, said portable information terminal characterized in that:
said magnetic core member is provided with a recess formed on a surface on which said base is stacked, at least in an area facing the loop portion of said antenna coil.

14. The portable information terminal as described in claim 13, characterized in that:
said recess is a ring-shaped groove formed in a region corresponding to the loop portion of said antenna.

15. The portable information terminal as described in claim 13, characterized in that:
said recess is dimples formed on the surface of said core member at a plurality of positions.

16. The portable information terminal as described in claim 13, characterized in that:
depth of said recess is less than 0.1 mm.

17. The portable information terminal as described in claim 13, characterized in that:
said magnetic core member is formed as a sheet by dispersing magnetic powders of Fe—Si—Cr system into binder.
